(19) United States
(12) Patent Application Publication
(10) Pub. No.: US 2017/0089745 A1
(43) Pub. Date: Mar. 30, 2017

(54) COMPENSATED FLUID LEVEL TRANSMITTER

(71) Applicant: HONEYWELL INTERNATIONAL INC., MORRIS PLAINS, NJ (US)

(72) Inventors: GEORGE HERSHEY, BLUE BELL, PA (US); MARK L. MULDOWNEY, CHALFONT, PA (US); ANTHONY F. DIGIULIAN, CHALFONT, PA (US); JOSEPH PANE, NORTH WALES, PA (US); JOSEPH R. GALLEN, HARLEYSVILLE, PA (US); ROGER W. BRILL, LANSDALE, PA (US)

(21) Appl. No.: 15/344,119

(22) Filed: Nov. 4, 2016

Related U.S. Application Data
(62) Division of application No. 14/463,310, filed on Aug. 19, 2014.

(51) Int. Cl. G01F 23/00; G01F 23/18

(52) U.S. Cl. CPC G01F 23/0076; G01F 23/18

(57) ABSTRACT

A fluid level transmitter combination for placement on a tank having ≦2 tank apertures. A first and second flange provides a first, second and third flange aperture over the tank aperture(s). A temperature sensor over the first flange aperture senses a temperature. A first pressure sensor over the second flange aperture senses a first pressure. A second pressure sensor senses a second pressure. A processor is coupled to the output of the second pressure sensor that implements a compensated fluid level determination algorithm using the temperature, first pressure, and second pressure to generate a compensated fluid level measurement for the process fluid. A transmitter is coupled to an output of the processor.

### CROSS REFERENCE TO RELATED APPLICATIONS

This application is a divisional application which claims the benefit of Non-Provisional Application Ser. No. 14/463,310 entitled “COMPENSATED FLUID LEVEL TRANSMITTER”, filed on Aug. 19, 2014, which is herein incorporated by reference in its entirety.

### FIELD

Disclosed embodiments relate to compensated fluid level transmitters for determining a level of a process fluid in a tank.

### BACKGROUND

Liquid level transmitters are well known for detecting the level of liquid in a tank using a sensor formed by a housing attached to the tank over a tank opening (tank aperture or a tank nozzle). Level transmitters use various technologies such as differential pressure, ultrasound or radar to measure the level of the process fluid in the tank.

Additional process measurements of temperature and pressure allow more accurate level calculations which compensate for changes in the density of the process fluid. These measurements generally require additional installation(s) by the user, specifically additional intrusions (penetrations) through the walls of the tank, welding, mounting stands, and additional wiring, which all add significant cost. The additional accuracy of the resulting compensated liquid level measurement as compared to an uncompensated liquid level measurement may not justify the added cost.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments include temperature and pressure compensated fluid (generally a liquid) level transmitter combinations configured for placement on a tank that have ≦2 tank apertures. A first and second flange includes a first, second and a third flange aperture over the tank aperture(s). A temperature sensor over the first flange aperture senses a temperature in the tank. A first pressure sensor over the second flange aperture senses a first pressure in the tank. A second pressure sensor is over the third aperture which senses a second pressure in the tank.

A processor is coupled to an output of the second pressure sensor, and is coupled to receive the first pressure and temperature, wherein the processor implements a compensated fluid level determination algorithm that uses the temperature, first pressure, and second pressure to generate a compensated fluid level measurement for the process fluid. In one embodiment the temperature and pressure measurement are integral in the same (mounting) flange used to install the level transmitter combination, so that only a single tank aperture is needed, and there is no need for additional mounting hardware.

### BRIEF DESCRIPTION OF THE DRAWINGS

FIG. 1 is a flow chart that shows steps in a method of fluid level sensing, according to an example embodiment.

FIG. 2 is a depiction of an example an example differential pressure-based multi-output remote seal level transmitter combination mounted on a tank, according to an example embodiment.

FIG. 3A is a depiction of an example radar-based level multi-output level transmitter combination mounted on the top of a tank, according to an example embodiment.

FIG. 3B is a depiction of an example ultrasound-based level multi-output level transmitter combination mounted on the top of a tank, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

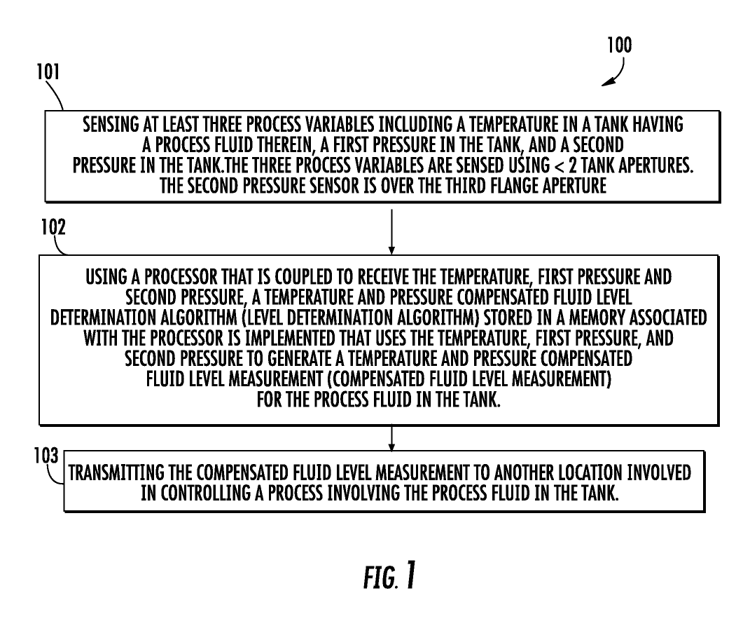

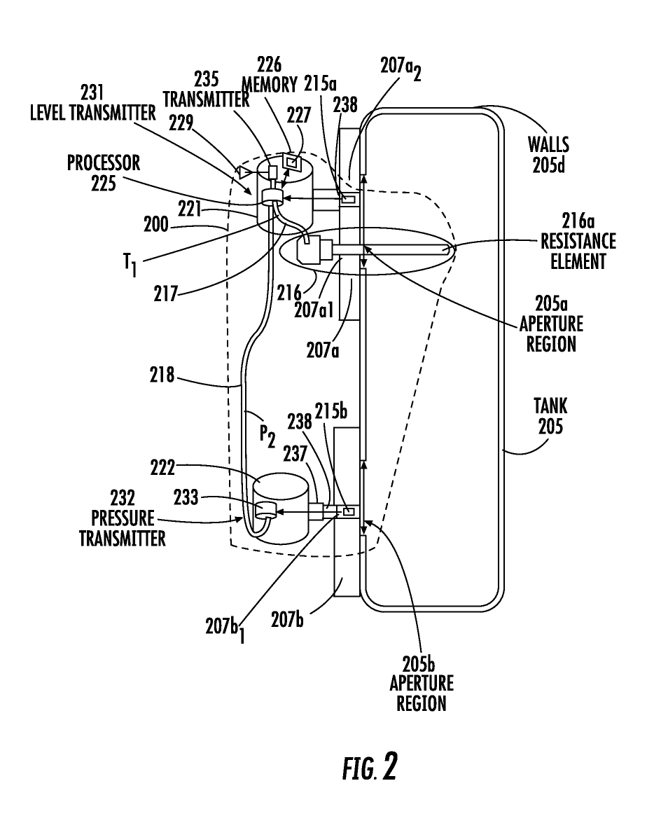

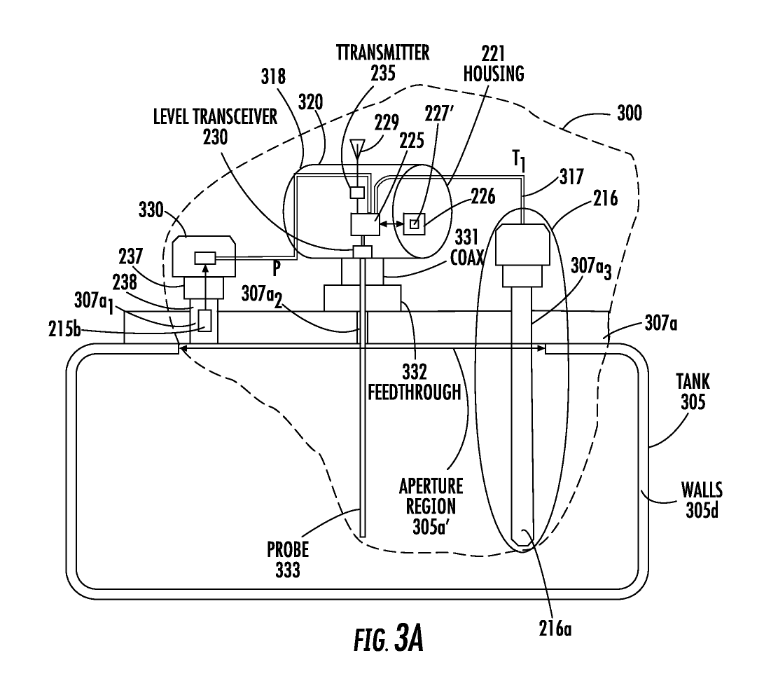

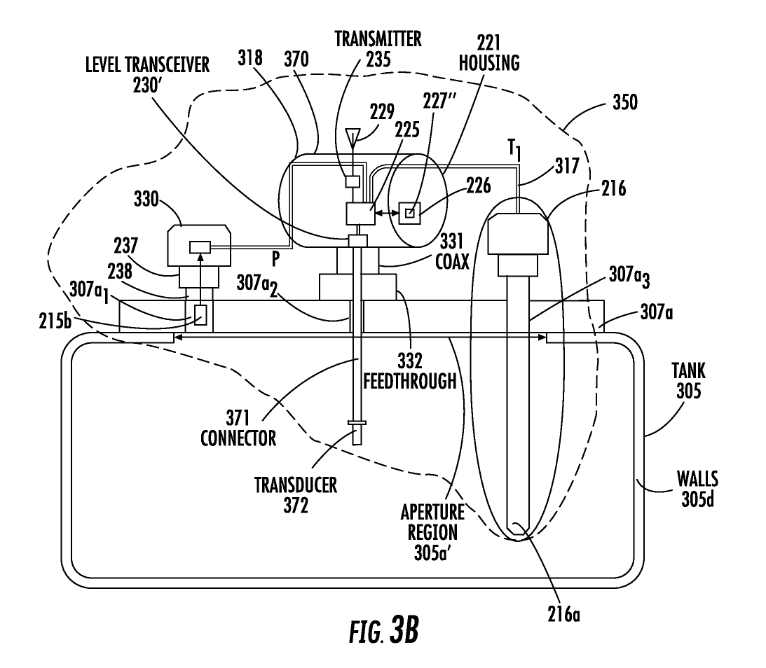

FIG. 1 is a flow chart that shows steps in a method 100 of fluid level sensing, according to an example embodiment. Step 101 comprises sensing at least three process variables including a temperature in a tank having a process fluid therein, a first pressure in the tank, and a second pressure in the tank. For guided wave radar (GWR) which is contact radar the probe extends from the flange into the fluid to allow surface reflection as the fluid level changes, while for non-contact radar the probe will be above the fluid level. The three process variables are sensed using at most two (2) tank apertures, where one or more flanges are over each tank aperture as shown in FIGS. 2 and FIG. 3A and FIG. 3B described below.

Step 102 comprises using a processor that is coupled to receive the temperature, first pressure and second pressure implementing a temperature and pressure compensated fluid level determination algorithm (level determination algorithm) stored in a memory associated with the processor. The level determination algorithm uses the temperature, first pressure, and second pressure to generate a temperature and pressure compensated fluid level measurement (compensated fluid level measurement) for the process fluid in the tank. For disclosed embodiments, where temperature, first pressure and second pressure are provided, level sensing is implemented by differential pressure (difference between the first pressure and the second pressure). Step 103 comprises transmitting the compensated fluid level measurement to another location involved in controlling a process involving the process fluid in the tank, such as to a control room(s) associated with a manufacturing or processing plant such as a refinery. The transmission can be implemented over the air with a wireless signal using an antenna (see antenna 229 in FIG. 2 described below), or by a wire or a cable.

FIG. 2 is a depiction of an example differential pressure-based multi-output remote seal level transmitter combination (level transmitter combination) 200 mounted on a tank 205, according to an example embodiment. Level transmitter combination 200 includes a top mounted level transmitter 231 which implements level sensing using differential pressure (IP2-P11). The tank 205 contains a process fluid (generally a liquid, not shown) and includes first tank aperture region 205a and a second tank aperture region 205b each defined by respective gaps (apertures) in the tank walls 205d.

A top flange 207a is over the first tank aperture region 205a and a bottom flange 207b is over the second tank aperture region 205b. The top flange 207a includes flange apertures 207a1 and 207a2. The bottom flange 207b includes a single flange aperture 207b1.

Level transmitter 231 is over the flange aperture 207a2 and the first tank aperture region 205a. Level transmitter 231 comprises a pressure sensor 215a that is within (integrated with) flange aperture 207a2. Pressure sensor 215a is generally mounted in a pressure case (not shown) that is secured to the bottom flange 207b. A temperature sensor 216 shown as a resistance element 216a such as a resistance temperature detector (RTD) is integrated with flange aperture 207a1. One set of connectors 237, 238 provide a seal to the top flange 207a for temperature sensor 216 and another set of connectors 237, 238 provide a seal to the top flange 207a for the level transmitter 231. The resistance element 216a is shown providing its temperature output (T1) as an input to the processor 225 (generally also an intervening filter and analog to digital converter (ADC) not shown here or elsewhere) of the level transmitter 231 by the interconnect 217 shown, such as by a cable or wire.

Processor 225 is within an electronics housing 221 and can comprise a microprocessor or a micro controller unit (MCU), where an output of the processor 225 is coupled to a transmitter 235 (generally also an intervening digital to analog converter (DAC) not shown here or elsewhere for simplicity) which is shown coupled to an optional antenna 229. Wireless or optical interconnect arrangements can generally also be used for all disclosed interconnects. The pressure sensor 215a senses P1.

The level transmitter combination 200 also includes a bottom mounted pressure transmitter 232 including a pressure sensor 215b that has a pressure case mounted within the flange aperture 207b1. Pressure transmitter 232 is shown including a set of connectors 237, 238 which provide a seal to the bottom flange 207b and coupling to the tank 205 through the flange apertures 207b1 of the bottom flange 207b and the second tank aperture region 205b.

The pressure sensor 215b which senses P2 is coupled to transmitter 233 that is within another electronics housing 222 that couples to processor 225 of level transmitter 231 (intervening filter and analog to digital converter (ADC) not shown here or elsewhere for simplicity) by the interconnect wiring 218 shown. Processor 225 thus receives T1 from temperature sensor 216, P1 from pressure sensor 215a, and P2 from pressure sensor 215b and implements a level determination algorithm 227 based on differential pressure (P2-P1) stored in a memory 226 associated with the processor 225.

The level determination algorithm 227 run by processor 225 generates a temperature and pressure compensated fluid level measurement for the fluid in the tank 205 which can be transmitted remotely, such as by an antenna 229, typically to one or more computer terminals in a control room. The output signal provided by level transmitter 231 can be an analog signal (e.g., a 4 ma to 20 mA signal) or a digital signal (e.g., a digital HART signal).

The fluid height in the tank 205 is found from the pressure difference between P1 and P2 (P2-P1) being the respective measured pressures in the tank. By measuring T1 the fluid level is also compensated for fluid density. Although the temperature sensor 216 is shown mounted on the top flange 207a, the temperature sensor 216 can alternatively be mounted on the bottom flange 207b. Moreover, although the level transmitter 231 is shown as the main transmitter for the level transmitter combination 200, pressure transmitter 232 may also include a processor, memory and a disclosed algorithm to enable it to function as the main transmitter for the level transmitter combination 200.

FIG. 3A is a depiction of an example radar-based level multi-output transmitter combination (level transmitter combination 300) mounted on the top of a tank 305, according to an example embodiment. Level transmitter combination 300 includes a radar level transmitter 320, pressure sensor 330, and a temperature sensor 216 shown as a RTD, which implements level sensing using radar. The tank 305 contains a process fluid (not shown) and includes only a single tank aperture region 305a defined by a gap in the top of the tank walls 305d. A top flange 307a having flange apertures 307a1, 307a2 and 307a3 is over tank aperture region 305a.

The radar level transmitter 320 uses radar pulses provided by a level transceiver 230 to continuously measure the distance to the surface of the liquid to enable a level measurement to be rendered. The level transceiver 230 is coupled to a metal probe 333 which is sealed and is through flange apertures 307a2 into the tank 305 by a coaxial connector (coax) 331 coupled to a feed-through 332. Pressure sensor 330 is over flange aperture 307a1 and tank apertures 305a which measures P, while the temperature sensor 216 shown as a RTD is over flange aperture 307a3 which measures T1. Processor 225 receives T1 via interconnect 317 and P from pressure sensor 330 via interconnect 318 and implements a radar-based level determination algorithm 227′ stored in memory 226 associated with the processor 225 using the radar echoes to determine fluid level for the fluid in the tank 305, and T1 and P to generate a compensated fluid level measurement for the fluid in the tank 305.

The output of processor 225 is coupled to an input of a transmitter 235 that as shown is coupled to antenna 229. Level transmitter combination 300 thus implements three process variables (P, T1 and fluid level (without fluid density compensation) from a single process penetration (tank aperture region 305a) to generate a fluid level measurement having fluid density compensation.

FIG. 3B is a depiction of an example ultrasound-based level multi-output transmitter combination 350 mounted on the top of a tank, according to an example embodiment. Level transmitter combination 350 includes an ultrasound level transmitter 370, and the pressure sensor 330 and temperature sensor 216 shown as a RTD described relative to level transmitter combination 300 shown in FIG. 3A. The ultrasound level transmitter 370 includes an electrically conductive (e.g., metal) connector 371 that couples an ultrasonic transducer (transducer) 372 comprising a piezoelectric crystal acting is a probe sensor to an associated level transceiver 230′ that has an output coupled to an input of the processor 225. The output of processor 225 is coupled to an input of the transmitter 235 that is shown coupled to antenna 229.

Together the transducer 372, level transceiver 230′ and processor 225 running an ultrasonic level determination algorithm 227″ operate to determine the time for a transmitted ultrasonic pulse and its reflected echo to make a complete return trip between the transducer 372 and the sensed material level. The transducer 372 directs sound waves downward in bursts onto the surface of the material whose level is to be measured, and the piezoelectric crystal inside the transducer 372 converts electrical pulses into sound energy that travels in the form of a wave at the established frequency and at a constant speed in a given medium. Echoes of these waves return to the transducer 372 which are coupled to the processor 225 that performs calculations to convert the distance of sound wave travel into a measure of the liquid level in the tank. The time lapse between firing the sound burst and receiving the return echo is directly proportional to the distance between the transducer 372 and the material in the vessel.

Disclosed embodiments can be applied to generally to any fluid level detection system. For example, as disclosed above to ultrasonic and radar-based systems. The radar-based system can be contact radar (e.g., GWR) or non-contact radar.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. A fluid level transmitter combination, comprising:
a first flange and a second flange configured for placement on a tank including no more than two (2) tank apertures that has a process fluid therein, said first and said second flange including at least a first, second and third flange aperture formed over said tank apertures;
a temperature sensor over said first flange aperture providing a temperature output signal for sensing a temperature in said tank;
a first pressure sensor over said second flange aperture having a first pressure output signal for sensing a first pressure in said tank, and
a second pressure sensor over said third flange aperture having a second pressure output sensing a second pressure in said tank;
a processor coupled to an output of said second pressure output, said processor implementing a temperature and pressure compensated fluid level determination algorithm (level determination algorithm) stored in associated memory;
a first connection coupling said temperature output signal to said processor, and a second connection coupling first pressure output signal to said processor,
wherein said level determination algorithm uses said temperature, said first pressure, and said second pressure to generate a temperature and pressure compensated fluid level measurement for said process fluid, and
a transmitter having an input coupled to an output of said processor.

2. The fluid level transmitter combination of claim 1, wherein said first connection and said second connection both comprise a wire or a cable connection.

3. The fluid level transmitter combination of claim 1, further comprising an antenna coupled to an output of said transmitter.

4. The fluid level transmitter combination of claim 1, further comprising an electronics housing that said processor is within, and another electronics housing that said transmitter is within.

5. A method of fluid level sensing, comprising:
sensing at least three process variables including a temperature in a tank having a process fluid therein, a first pressure in said tank, and a second pressure in said tank, wherein said three process variables are sensed using a first flange and a second flange, first, second and third flange apertures and at most two (2) tank apertures wherein a second pressure sensor is over said third flange aperture;
using a processor that is coupled to receive said temperature, said first pressure and said second pressure, implementing a temperature and pressure compensated fluid level determination algorithm (level determination algorithm) stored in memory associated with said processor;
wherein said level determination algorithm uses said temperature, said first pressure, and said second pressure to generate a temperature and pressure compensated fluid level measurement for said process fluid.

6. The method of claim 5, further comprising transmitting said compensated fluid level measurement to at least one remote location involved in controlling a process involving said process fluid in said tank.

7. A controlled processing tank, comprising:
tank walls defining no more than two (2) tank apertures having a process fluid in said tank;
a first flange and a second flange on said tank including at least a first, second and third flange aperture formed over said tank apertures;
a temperature sensor over said first flange aperture providing a temperature output signal for sensing a temperature in said tank having said process fluid therein;
a first pressure sensor over said second flange aperture having a first pressure output signal for sensing a first pressure in said tank, and
a second pressure sensor over said third flange aperture having a second pressure output sensing a second pressure in said tank;
a processor coupled to said second pressure output, said processor implementing a temperature and pressure compensated fluid level determination algorithm (level determination algorithm) stored in associated memory;
a first connection coupling said temperature output signal to said processor, and a second connection coupling first pressure output signal to said processor,
wherein said level determination algorithm uses said temperature, said first pressure, and said second pressure to generate a temperature and pressure compensated fluid level measurement for said process fluid, and
a transmitter having an input coupled to an output of said processor.

8. The controlled processing tank of claim 7, further comprising an antenna coupled to an output of said transmitter.

9. The controlled processing tank of claim 7, further comprising an electronics housing that said processor is within, and another electronics housing that said transmitter is within.
